(19) United States
(12) Patent Application Publication
(10) Pub. No.: US 2025/0117678 A1
(43) Pub. Date: Apr. 10, 2025

(54) COMPACT QUANTUM CIRCUIT SCHEDULING

(71) Applicant: International Business Machines Corporation, Armonk, NY (US)

(72) Inventors: Petar Jurcevic, San Jose, CA (US); Ali Javadiabhari, Sleepy Hollow, NY (US); Toshinari Itoko, Chigasaki-shi (JP)

(21) Appl. No.: 18/481,661

(22) Filed: Oct. 5, 2023

(51) Int. Cl. G06N 10/20; G06N 10/70

(52) U.S. Cl. CPC G06N 10/20; G06N 10/70

(57) ABSTRACT

Systems and techniques that facilitate compact quantum circuit scheduling are provided. For example, one or more embodiments described herein can comprise a system, which can comprise a memory that can store computer executable components. The system can also comprise a processor, operably coupled to the memory that can execute the computer executable components stored in memory. The computer executable components can comprise a scheduling component that creates an operations schedule for executing a quantum circuit on a quantum computer, wherein creating the operations schedule comprises determining an idle time between a first operation and a second operation on a qubit in the quantum circuit and reducing the idle time between the first operation and the second operation to create the operations schedule.

### BACKGROUND

The subject disclosure relates to quantum circuit scheduling, and more specifically, scheduling that reduces idle time of qubits within a quantum circuit.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate compact quantum circuit scheduling are provided.

According to an embodiment, a system can comprise a processor that executes computer executable components stored in memory. The computer executable components can comprise a scheduling component that creates an operations schedule for executing a quantum circuit on a quantum computer, wherein creating the operations schedule comprises determining an idle time between a first operation and a second operation on a qubit in the quantum circuit and reducing the idle time between the first operation and the second operation to create the operations schedule. An advantage of such a system is that by reducing idle time of qubits, quantum errors can be reduced, thereby providing more accurate quantum results.

According to another embodiment, a computer-implemented method can comprise, creating, by a system operatively coupled to a processor, an operations schedule for executing a quantum circuit on a quantum computer, wherein creating the operations schedule comprises determining an idle time between a first operation and a second operation on a qubit in the quantum circuit and reducing the idle time between the first operation and the second operation to create the operations schedule. An advantage of such a computer implemented method is that by reducing idle time of qubits, quantum errors can be reduced, thereby providing more accurate quantum results.

According to another embodiment, a computer program product can comprise a computer readable storage medium having program instructions embodied therewith, the program instructions executable by a processor to cause the processor to create, by the processor, an operations schedule for executing a quantum circuit on a quantum computer, wherein creating the operations schedule comprises determining an idle time between a first operation and a second operation on a qubit in the quantum circuit and reducing the idle time between the first operation and the second operation to create the operations schedule. An advantage of such a computer program product is that by reducing idle time of qubits, quantum errors can be reduced, thereby providing more accurate quantum results.

### DESCRIPTION OF THE DRAWINGS

FIG. 1 illustrates a block diagram of an example, non-limiting system that can facilitate compact quantum circuit scheduling and execution in accordance with one or more embodiments described herein.

FIG. 2 illustrates an example quantum circuit in accordance with one or more embodiments described herein.

FIG. 3 illustrates an example of ALAP quantum scheduling of the circuit of FIG. 2 in accordance with one or more embodiments described herein.

FIG. 4 illustrates an example of ASAP quantum scheduling of the circuit of FIG. 2 in accordance with one or more embodiments described herein.

FIG. 5 illustrates an example of compact scheduling of the circuit of FIG. 2 in accordance with one or more embodiments described herein.

FIG. 6 illustrates a flow diagram of an example, non-limiting, computer implemented method that can facilitate compact scheduling of quantum circuits in accordance with one or more embodiments described herein.

FIG. 7 illustrates a flow diagram of an example, non-limiting, computer implemented method that facilitates compact scheduling in accordance with one or more embodiments described herein.

FIG. 8 illustrates a flow diagram of an example, non-limiting, computer implemented method that facilitates compact scheduling in accordance with one or more embodiments described herein.

FIG. 9 illustrates a block diagram of an example, non-limiting system that can complete execution of a quantum job in accordance with one or more embodiments described herein.

FIG. 10 illustrates an example, non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

Quantum computing is generally the use of quantum-mechanical phenomena for the purpose of executing computing and information processing functions. Quantum computing can be viewed in contrast to classical computing, which generally operates on binary values with transistors. That is, while classical computers can operate on bit values that are either 0 or 1, quantum computers operate on quantum bits (qubits) that comprise superpositions of both 0 and 1, can entangle multiple quantum bits, and use interference.

Quantum computing can be done in one of two methods, simulation or execution on real quantum hardware. Executing circuits on real quantum hardware comes with a choice of how to time performance of the actual gates, as physical gates are not instantaneous to perform in contrast to simulation. Accordingly, two different time schemes are currently utilized to align pules within quantum circuits on real hardware, aligning the initial gates (e.g., as soon as possible or ASAP) or aligning the final gates (e.g., as late as possible or ALAP). Both of these schemes provide disadvantages to performance of the quantum circuit. As utilized herein idle time can refer to the time in which a qubit is left waiting between operations (e.g., use of the qubit to execute a gate operation, a measurement operation on the qubit, or another operation). As utilized herein operations schedule can refer to the order and timing at which gates, measurements and/or other operations are executed on qubits as part of an execution of a quantum circuit.

Within ASAP, all qubits are aligned with the first pulse utilized. Accordingly, all qubits are brought out of ground state |0> at the same time, regardless of whether the qubit will be utilized at this time. This idle time leaves the qubits sensitive to decay and dephasing between being brought out of the ground state, and further gate operations, which decrease accuracy of the operations performed.

Within ALAP, all qubits initialized to the ground state, and are left in the ground state until a gate is scheduled to be performed utilizing the gate. Once all gates have been completed, measurements are taken of all qubits. While this prevents decay and dephasing before performance of gates, qubits are often left idling between completion of gates and measurements, leaving the qubits sensitive to accumulation of phase errors and amplitude damping.

In view of the problems discussed above, the present disclosure can be implemented to produce a solution to one or more of these problems by creating an operations schedule for executing a quantum circuit on a quantum computer, wherein creating the operations schedule comprises determining an idle time between a first operation and a second operation on a qubit in the quantum circuit and reducing the idle time between the first operation and the second operation to create the operations schedule. For example, if given an ASAP schedule, the reducing the idle time can comprise determining, for each operation G in the quantum circuit in reverse topological order, an idle time behind operation G over all qubits on which operation G acts; and moving scheduling of operation G backwards in response to a determining that the idle time is non-zero. In a further example, given an ALAP schedule, the reducing the idle time can comprise determining, for each operation G in the quantum circuit in topological order, an idle time in front of operation G over all qubits on which operation G acts; and moving scheduling of operation G forward in response to a determining that the idle time is non-zero.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

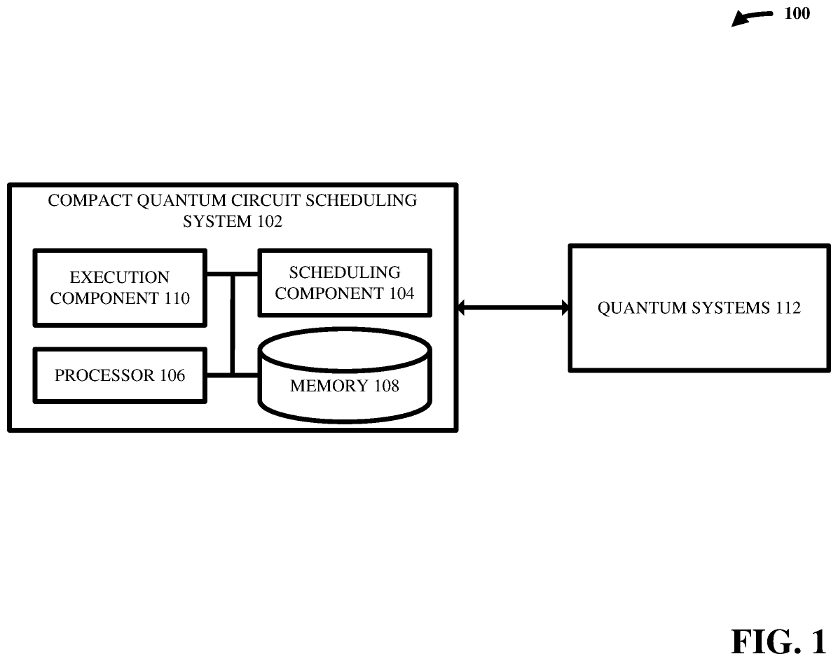

FIG. 1 illustrates block diagram of an example, non-limiting system 100 that can facilitate compact scheduling of quantum circuits in accordance with one or more embodiments described herein. Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise scheduling component 104, execution component 110, quantum systems 112, processor 106 and memory 108.

In various embodiments, compact quantum circuit scheduling system 102 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the system 102 (e.g., scheduling component 104, execution component 110, and/or quantum systems 112) to perform one or more acts. In various embodiments, the memory 108 can store computer-executable components (e.g., scheduling component 104, execution component 110, and/or quantum systems 112), the processor 106 can execute the computer-executable components.

In one or more embodiments, scheduling component 104 can create an operations schedule for executing a quantum circuit, wherein creating the operations schedule comprises determining an idle time between a first operation and a second operation on a qubit in the quantum circuit and reducing the idle time between the first operation and the second operation on a qubit in the quantum circuit to create the operations schedule. As defined herein, idle time comprises the amount of time a qubit sits idling ow waiting between operations such as initialization, performance of a gate, measurement of the qubit state or other operations. In an embodiment, scheduling component 104 can first order circuit operations utilizing either ASAP or ALAP scheduling. If ASAP scheduling is utilized, all qubits within the circuit will be scheduled to be initialized when the when the first gate in the circuit is to be performed. If ALAP scheduling is utilized, all measurement operations are scheduled to take place after the last gate in the circuit is performed.

If scheduling component 104 utilizes ASAP scheduling, scheduling component 104 can sort the operation of the quantum circuit in reverse topological order (e.g., utilizing a reverse topological sort algorithm). Scheduling component 104 can then select a first operation (e.g., an initialization, a gate and/or a measurement pulse) G from the reverse topological order and determine if the operation G is the last gate or operation to act on a qubit, if so, then scheduling component 104 can proceed to the next gate in reverse topological order. If operation G is not the last operation for a qubit, scheduling component 104 can determine an idle time behind the selected operation G over all qubits on which operation G acts and move the scheduling of operation G backwards in time in response to determining that the idle time is non-zero. Accordingly, idle time between a first operation (e.g., operation G) and a second operation (e.g., the next operation that acts on the qubit after operation G) is reduced. For example, if the selected operation is a gate which acts on two qubits, q₀ and q₁, and the idle time for both q₀ and q₁, is non-zero, the operation time of operation G can be moved until the idle time of at least one of q₀ and q₁ is zero.

If scheduling component 104 utilizes ALAP scheduling, scheduling component 104 can sort the operations of the quantum circuit in topological order (e.g., utilizing a reverse topological sort algorithm). Scheduling component 104 can then select a first operation G from the topological order and determine if the operation G is the first gate or operation to act on a qubit. If so, then scheduling component 104 can proceed to the next gate in topological order. If operation G is not the first gate for a qubit, scheduling component 104 can determine an idle time in front of the selected operation G over all qubits on which operation G acts and move the scheduling of operation G forwards in time in response to determining that the idle time is non-zero. Accordingly, idle time between a first operation (e.g., the gate which acts on the qubit before operation G) and a second operation (e.g., operation G) is reduced. For example, if the selected operation is a gate which acts on two qubits, q₀ and q₁, and the idle time for both q₀ and q₁, is non-zero, the operation time of operation G can be moved until the idle time of at least one of q₀ and q₁ is zero. In both examples, once scheduling component 104 has iterated through all operations in the quantum circuit scheduling component 104 can pass the generated operations schedule to execution component 110 to execute the operations schedule on quantum systems 112.

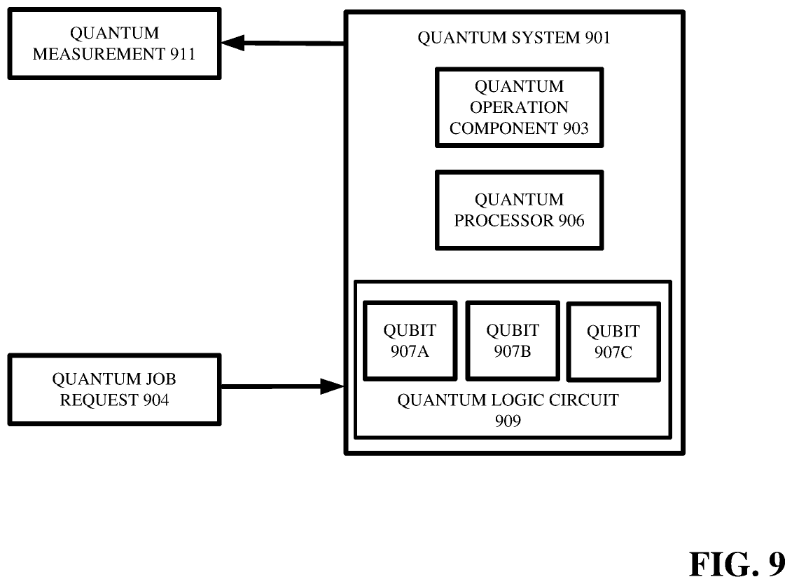

In an embodiment, quantum systems 112 can comprise one or more quantum computers, such as that described in greater detail below in reference to FIG. 9, and/or one or more quantum simulators. Based on parameters such as capabilities of the quantum computers, availability of the quantum computers, and/or criteria specified by an entity, such as preferred quantum computers, preferred runtime, etc., execution component 110 can execute the quantum circuit on the quantum systems 112 utilizing the operations schedule as instructions on when to perform gates or quantum operations. In another embodiment, execution component 110 can store the operations schedule in a database for future use. Accordingly, if the same quantum circuit is to be executed again in the future, the operations schedule can be retrieved from memory, rather than being generated a second time.

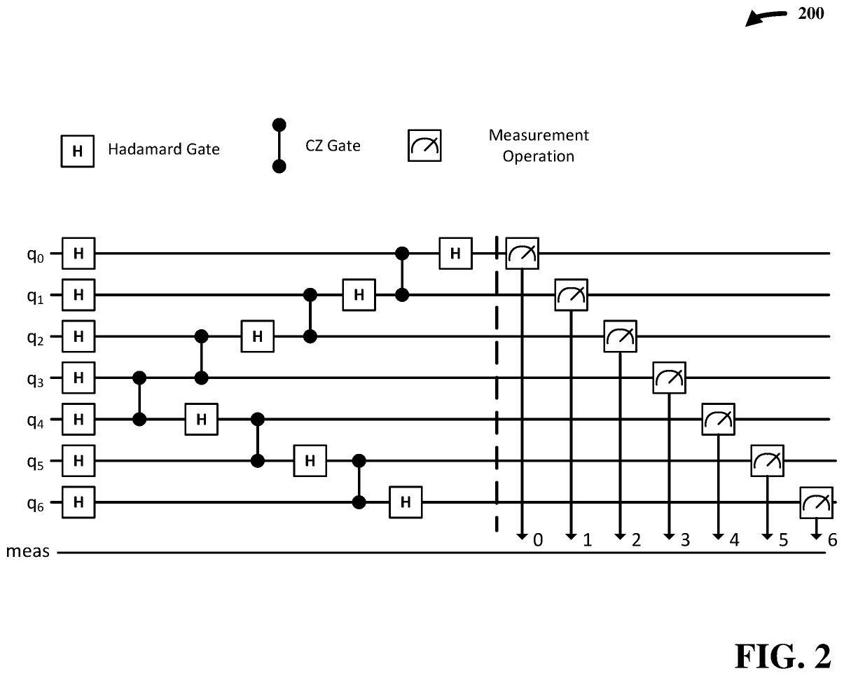

FIG. 2 illustrates an example quantum circuit 200 in accordance with one or more embodiments described herein. As shown, circuit 200 comprises qubits q₀ through q₆ and a series of Hadamard gates and CZ gates that act upon qubits q₀ through q₆ before each qubit is measured.

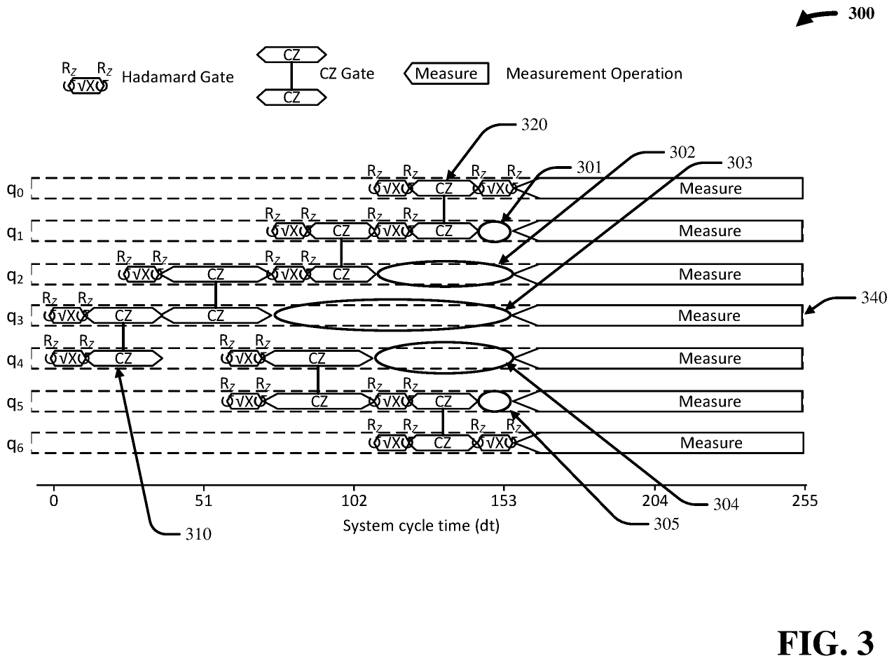

FIG. 3 illustrates an example of ALAP quantum scheduling of the circuit of FIG. 2 in accordance with one or more embodiments described herein.

As shown, when using ALAP scheduling, qubits q₀ through q₆ are not brought out of the ground state until they are scheduled to perform a gate. For example, qubits q₃ and q₄ are initialized at system cycle time 0 in order to perform CZ gate 310. In contrast, qubit q₀ is not initialized until after system cycle time 102 to perform gate 320. All measurement pulses are then applied at system cycle time 153. However, as shown qubits q₂ through q₅, have idle times 301, 302, 303, 304 and 305 between the previous gate operation utilizing the qubit and the measurement pulses. This idle time can introduce phase error and amplitude damping to the qubits, thereby producing less accurate results when measured.

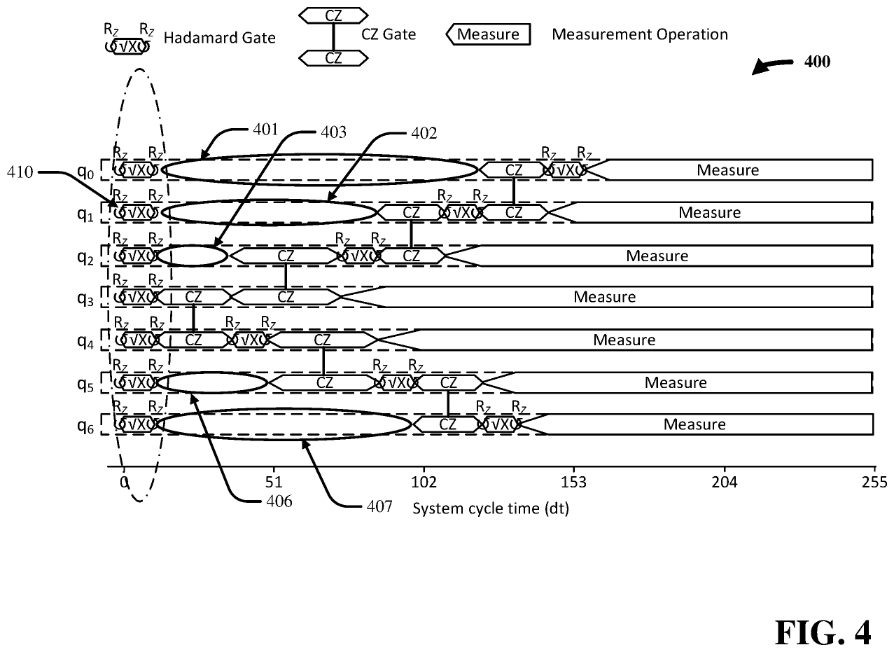

FIG. 4 illustrates an example of ASAP quantum scheduling of the circuit of FIG. 2 in accordance with one or more embodiments described herein.

As shown, when using ASAP all qubits are brought out of the ground state together at 410. However, qubits q₀ through q₂ and qubits q₅ through q₆ have idle times 401, 402, 403, 406 and 407 respectively between initialization and performance of the first gate operation utilizing the qubits. This allows for decay and dephasing of the qubits q₀ through q₂ and qubits q₅ through q₆, thereby decreasing accuracy of the performed operations.

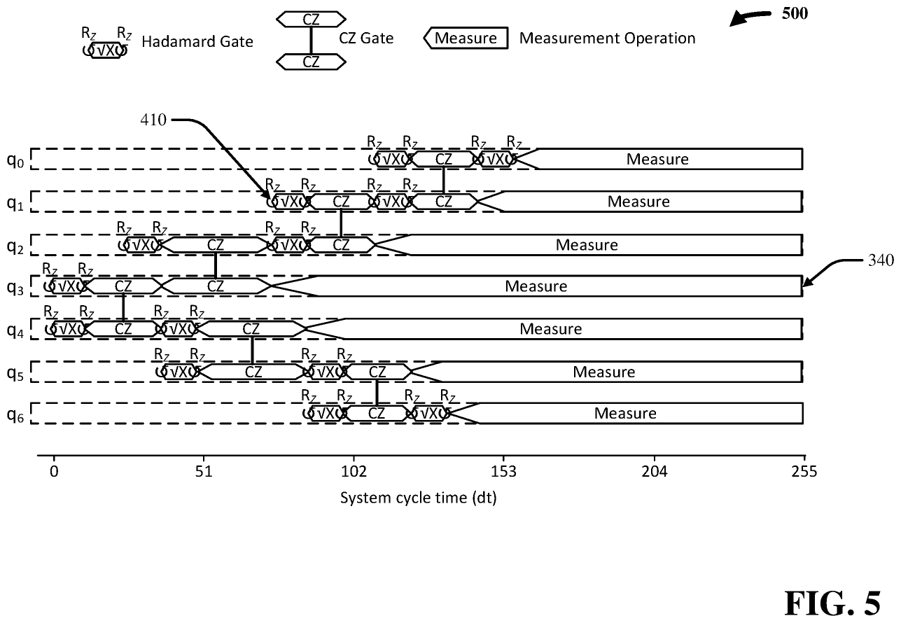

FIG. 5 illustrates an example of compact scheduling of the circuit of FIG. 2 in accordance with one or more embodiments described herein.

As, shown, schedule 500 does not have the idle times (e.g., 301, 302, 303, 304 and 305 of FIGS. 3 and 401, 402, 403, 406 and 407 of FIG. 4) due to the use of the scheduling algorithm as described above in reference to scheduling component 104 of FIG. 1. In an embodiment, given ALAP schedule 300, scheduling component 104 can sort the operations of the quantum circuit in topological order (e.g., utilizing a topological sort algorithm). Scheduling component 104 can then select a first operation G from the topological order, and determine if the operation G is the first operation to act on a qubit. If so, then scheduling component 104 can proceed to the next operation in topological order. If operation G is not the first operation for a qubit, scheduling component 104 can determine an idle time in front of the selected operation G over all qubits on which operation G acts and move the scheduling of operation G forwards in time in response to determining that the idle time is non-zero. For example, when scheduling component 104 iterates to measurement operation 340 of FIG. 3, scheduling component 104 can determine that measurement operation 340 is not the first operation to act on qubit q₃, and that there is non-zero idle time (idle time 303) ahead of measurement operation 340. Accordingly, measurement operation 340 can be moved forward in time as shown in FIG. 5.

In another embodiment, given ASAP schedule 400, scheduling component 104 can sort the operations of the quantum circuit in reverse topological order (e.g., utilizing a reverse topological sort algorithm). Scheduling component 104 can then select a first operation G from the reverse topological order and determine if the operation G is the last operation to act on a qubit, if so, then scheduling component 104 can proceed to the next operation in reverse topological order. If operation G is not the last operation for a qubit, scheduling component 104 can determine an idle time behind of the selected operation G over all qubits on which operation G acts and move the scheduling of operation G backwards in time in response to determining that the idle time is non-zero. For example, when scheduling component 104 iterates to Hadamard gate 410, scheduling component 104 can determine that gate 410 is not the last gate to act on qubit q₁, and that there is a non-zero idle time (idle time 402) behind gate 410. Accordingly, Hadamard gate 410 can be moved backwards in time as shown in FIG. 5.

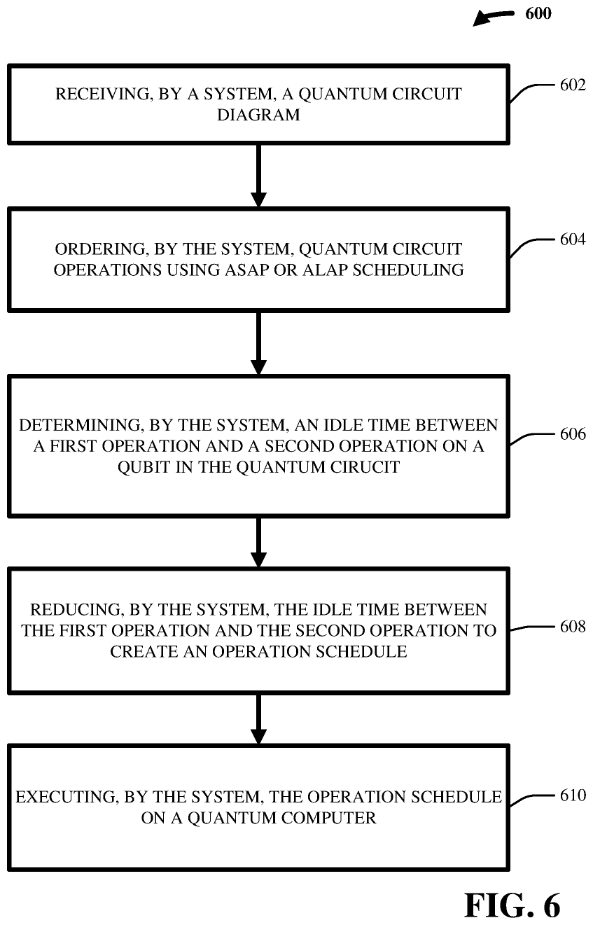

FIG. 6 illustrates a flow diagram of an example, non-limiting, computer implemented method 600 that can facilitate compact scheduling of quantum circuits in accordance with one or more embodiments described herein.

At 602, method 600 can comprise receiving, by a system (e.g., system 102 and/or scheduling component 104) operatively coupled to a processor (e.g., processor 106), a quantum circuit diagram of a circuit to be performed by a quantum computer (e.g., quantum systems 112).

At 604, method 600 can comprise ordering, by the system (e.g., system 102 and/or scheduling component 104), quantum circuit operations using ASAP or ALAP scheduling. For example, as described above in greater detail in reference to FIGS. 1-4, scheduling component 104 can align either the first operations of the quantum circuit (ASAP) or the last operation (ALAP).

At 606, method 600 can comprise determining, by the system (e.g., system 102 and/or scheduling component 104), an idle time between a first operation and a second operation on a qubit in the quantum circuit.

At 608, method 600 can comprise reducing, by the system (e.g., system 102 and/or scheduling component 104), the idle time between the first operation and the second operation to create an operations schedule. For example, as described in greater detail above in relation to FIGS. 1, 3, 4 and 5, scheduling component 104 can move an operation forward or backwards in time in order to reduce or eliminate idle times of qubits.

At 610, method 600 can comprise executing, by the system (e.g., system 102, execution component 110 and/or quantum systems 112), the operations schedule on a quantum computer.

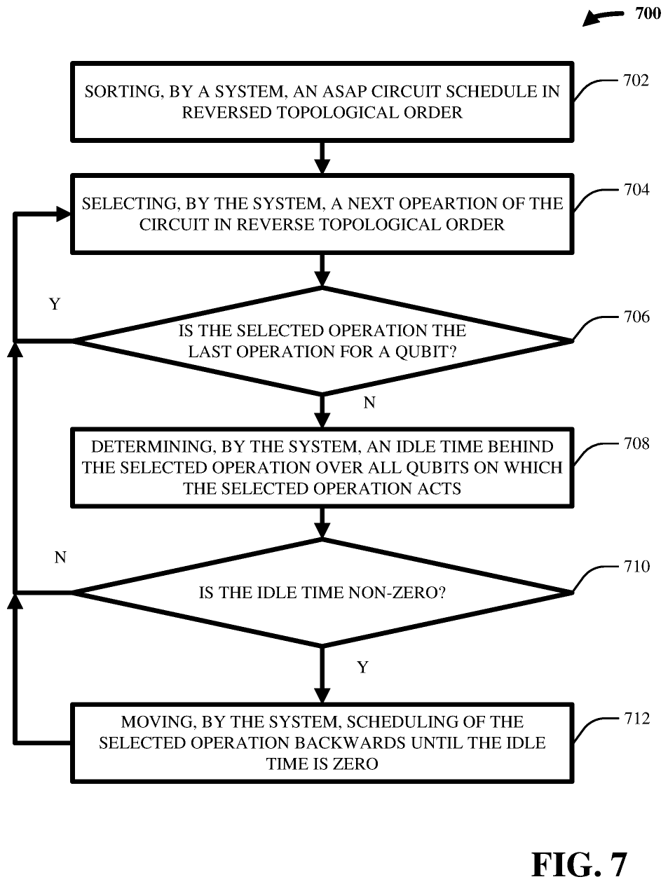

FIG. 7 illustrates a flow diagram of an example, non-limiting, computer implemented method 700 that facilitates compact scheduling in accordance with one or more embodiments described herein.

At 702, method 700 can comprise sorting, by a system (e.g., system 102 and/or scheduling component 104) operatively coupled to a processor (e.g., processor 106), an ASAP circuit schedule in reversed topological order.

At 704, method 700 can comprise selecting, by the system (e.g., system 102 and/or scheduling component 104), a next operation of the circuit in reverse topological order.

At 706, method 700 can comprise determining, by the system (e.g., system 102 and/or scheduling component 104), if the selected operation is the last gate to act on a qubit. If the determination is NO, then method 700 can proceed to step 708. If the determination is YES, then method 700 can return to step 704 can select a next operation of the circuit in reverse topological order.

At 708, method 700 can comprise determining, by the system (e.g., system 102 and/or scheduling component 104), an idle time behind the selected operation over all qubits on which the selected operation acts.

At 710, method 700 can comprise determining, by the system (e.g., system 102 and/or scheduling component 104), if the idle time is non-zero over all qubits on which the selected operation acts. If the determination is YES, then method 700 can proceed to step 712. If the determination is NO, then method 700 can return to step 704 can select a next operation of the circuit in reverse topological order. For example, if the selected operation is a gate which acts on two qubits, q₀ and q₁, and the idle time for both q₀ and q₁, is non-zero, method 700 can proceed to step 712.

At 712, method 700 can comprise moving, by the system (e.g., system 102 and/or scheduling component 104), scheduling of the selected operation backwards until the idle time is zero. For example, when scheduling component 104 iterates to measurement operation 340 of FIG. 3, scheduling component 104 can determine that measurement operation 340 is not the first operation to act on qubit q₃, and that there is non-zero idle time (idle time 303) ahead of measurement operation 340. Accordingly, measurement operation 340 can be moved forward in time as shown in FIG. 5.

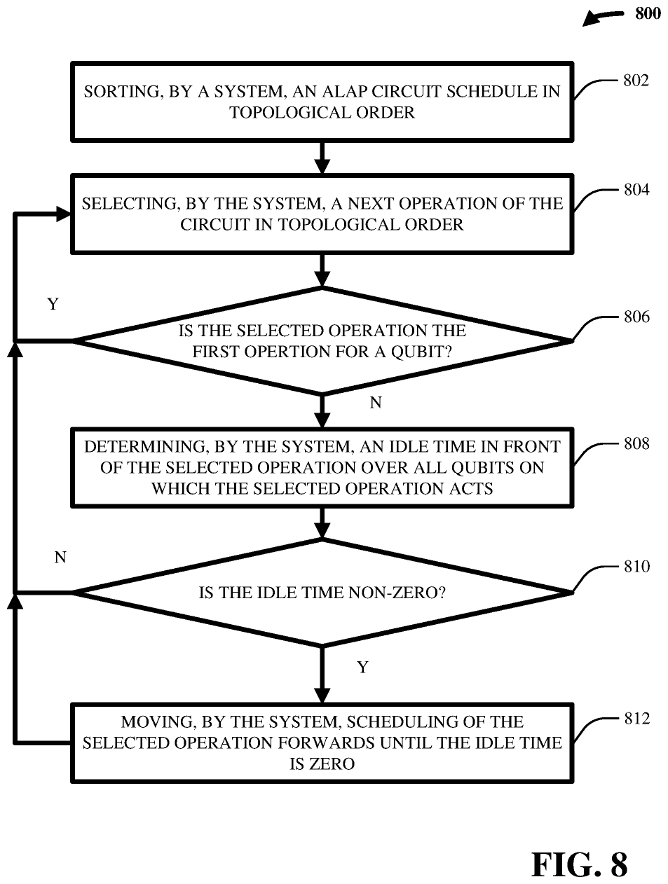

FIG. 8 illustrates a flow diagram of an example, non-limiting, computer implemented method 800 that facilitates compact scheduling in accordance with one or more embodiments described herein.

At 802, method 800 can comprise sorting, by a system (e.g., system 102 and/or scheduling component 104) operatively coupled to a processor (e.g., processor 106), an ALAP circuit schedule in topological order.

At 804, method 800 can comprise selecting, by the system (e.g., system 102 and/or scheduling component 104), a next operation of the circuit in topological order.

At 806, method 800 can comprise determining, by the system (e.g., system 102 and/or scheduling component 104), if the selected operation is the first gate to act on a qubit. If the determination is NO, then method 800 can proceed to step 808. If the determination is YES, then method 800 can return to step 804 can select a next operation of the circuit in reverse order.

At 808, method 800 can comprise determining, by the system (e.g., system 102 and/or scheduling component 104), an idle time in front of the selected operation over all qubits on which the selected operation acts.

At 810, method 800 can comprise determining, by the system (e.g., system 102 and/or scheduling component 104), if the idle time is non-zero over all qubits on which the selected operation acts. If the determination is YES, then method 800 can proceed to step 812. If the determination is NO, then method 800 can return to step 804 can select a next operation of the circuit in reverse topological order. For example, if the selected operation is a gate which acts on two qubits, q₀ and q₁, and the idle time for both q₀ and q₁, is non-zero, method 800 can proceed to step 812.

At 812, method 800 can comprise moving, by the system (e.g., system 102 and/or scheduling component 104), scheduling of the selected operation forwards until the idle time is zero. For example, as described above in reference to FIGS. 4 and 5, when scheduling component 104 iterates to Hadamard gate 410, scheduling component 104 can determine that gate 410 is not the last operation to act on qubit q₁, and that there is a non-zero idle time (idle time 402) behind gate 410.

Turning generally to FIG. 9, one or more embodiments described herein can include one or more devices, systems and/or apparatuses that can facilitate executing one or more quantum operations to facilitate output of one or more quantum results. For example, FIG. 9 illustrates a block diagram of an example, non-limiting system 900 that can complete the execution of a quantum job.

The quantum system 901 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement 911, can be responsive to the quantum job request 904 (e.g., the compact operations schedule produced by schedule component 104) and associated input data and can be based at least in part on the input data, quantum functions and/or quantum computations.

In one or more embodiments, the quantum system 901 can comprise one or more quantum components, such as a quantum operation component 903, a quantum processor 906 and a quantum logic circuit 909 comprising one or more qubits (e.g., qubits 907A, 907B and/or 907C), also referred to herein as qubit devices 907A, 907B and 907C. The quantum processor 906 can be any suitable processor, such as being capable of controlling qubit coherence and the like. The quantum processor 906 can generate one or more instructions for controlling the one or more processes of the quantum operation component 903.

The quantum operation component 903 that can obtain (e.g., download, receive, search for and/or the like) a quantum job request 904 requesting execution of one or more quantum programs. The quantum operation component 903 can determine one or more quantum logic circuits, such as the quantum logic circuit 909, for executing the quantum program. The request 904 can be provided in any suitable format, such as a text format, binary format and/or another suitable format. In one or more embodiments, the request 904 can be received by a component other than a component of the quantum system 901, such as a by a component of a classical system coupled to and/or in communication with the quantum system 901.

The quantum operation component 903 can perform one or more quantum processes, calculations and/or measurements for operating one or more quantum circuits on the one or more qubits 907A, 907B and/or 907C. For example, the quantum operation component 903 can operate one or more qubit effectors, such as qubit oscillators, harmonic oscillators, pulse generators and/or the like to cause one or more pulses to stimulate and/or manipulate the state(s) of the one or more qubits 907A. 907B and/or 907C comprised by the quantum system 901. That is, the quantum operation component 903, such as in combination with the quantum processor 906, can execute operation of a quantum logic circuit on one or more qubits of the circuit (e.g., qubit 907A, 907B and/or 907C). The quantum operation component 903 can output one or more quantum job results, such as one or more quantum measurements 999, in response to the quantum job request 904.

It will be appreciated that the following description(s) refer(s) to the operation of a single quantum program from a single quantum job request. However, it also will be appreciated that one or more of the processes described herein can be scalable, such as execution of one or more quantum programs and/or quantum job requests in parallel with one another.

In one or more embodiments, the non-limiting system 900 can be a hybrid system and thus can include both one or more classical systems, such as a quantum program implementation system, and one or more quantum systems, such as the quantum system 901. In one or more other embodiments, the quantum system 901 can be separate from, but function in combination with, a classical system.

In such case, one or more communications between one or more components of the non-limiting system 900 and a classical system can be facilitated by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Arca Networks), Z-Wave, an ANT, an ultra-wideband (UWB) standard protocol and/or other proprietary and/or non-proprietary communication protocols.

System 102 can provide technological improvements to a quantum computer associated with system 102. For example, by reducing and/or eliminating idle time of qubits in quantum circuits, quantum errors and decay can be reduced, thereby improving the accuracy and speed of quantum operations. System 102 can thereby facilitate improved performance, improved efficiency, and/or reduced computational cost associated with such a quantum computer.

It is to be appreciated that system 102 can utilize various combination of electrical components, mechanical components, and circuitry that cannot be replicated in the mind of a human or performed by a human as the various operations that can be executed by system 102 and/or components thereof as described herein are operations that are greater than the capability of a human mind. For instance, the amount of data processed, the speed of processing such data, or the types of data processed by system 102 over a certain period of time can be greater, faster, or different than the amount, speed, or data type that can be processed by a human mind over the same period of time. In an example, a human mind cannot perform quantum computations associated with phases of qubits or measure phases of qubits. According to several embodiments, system 102 can also be fully operational towards executing one or more other functions (e.g., fully powered on, fully executed, and/or another function) while also executing the various operations described herein. It should be appreciated that such simultaneous multi-operational execution is beyond the capability of a human mind. It should be appreciated that system 102 can include information that is impossible to obtain manually by an entity, such as a human user. For example, the type, amount, and/or variety of information included in system 102 can be more complex than information obtained manually by an entity, such as a human user.

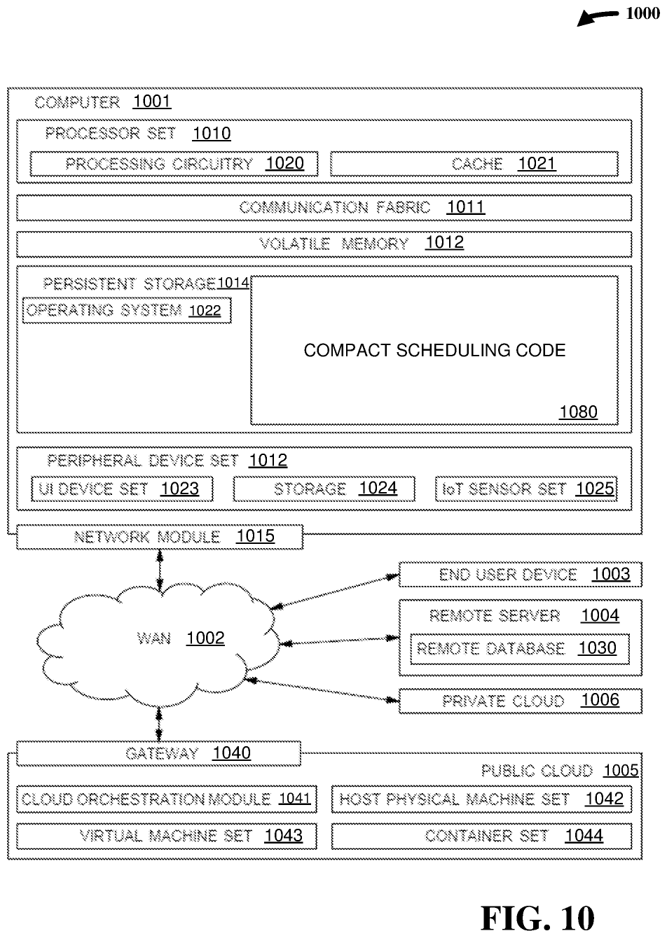

FIG. 10 and the following discussion are intended to provide a brief, general description of a suitable computing environment 1000 in which one or more embodiments described herein at FIGS. 1-9 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the compact scheduling code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1080, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method can be distributed among multiple computers and/or between multiple locations. On the other hand, in this presentation of computing environment 1000, detailed discussion is focused on a single computer, specifically computer 1001, to keep the presentation as simple as possible. Computer 1001 can be located in a cloud, even though it is not shown in a cloud in FIG. 10. On the other hand, computer 1001 is not required to be in a cloud except to any extent as can be affirmatively indicated.

PROCESSOR SET 1010 includes one, or more, computer processors of any type now known or to be developed in the future. Processing circuitry 1020 can be distributed over multiple packages, for example, multiple, coordinated integrated circuit chips. Processing circuitry 1020 can implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set can be located “off chip.” In some computing environments, processor set 1010 can be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods can be stored in block 1080 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory can be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 can be a read only memory (ROM), but typically at least a portion of the persistent storage allows writing of data, deletion of data and re-writing of data. Some familiar forms of persistent storage include magnetic disks and solid-state storage devices. Operating system 1022 can take several forms, such as various known proprietary operating systems or open-source Portable Operating System Interface type operating systems that employ a kernel. The code included in block 1080 typically includes at least some of the computer code involved in performing the inventive methods.

PERIPHERAL DEVICE SET 1014 includes the set of peripheral devices of computer 1001. Data communication connections between the peripheral devices and the other components of computer 1001 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 can include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 can be persistent and/or volatile. In some embodiments, storage 1024 can take the form of a quantum computing storage device for storing data in the form of qubits. In embodiments where computer 1001 is required to have a large amount of storage (for example, where computer 1001 locally stores and manages a large database) then this storage can be provided by peripheral storage devices designed for storing large amounts of data, such as a storage area network (SAN) that is shared by multiple, geographically distributed computers. IoT sensor set 1025 is made up of sensors that can be used in Internet of Things applications. For example, one sensor can be a thermometer and another sensor can be a motion detector.

NETWORK MODULE 1015 is the collection of computer software, hardware, and firmware that allows computer 1001 to communicate with other computers through WAN 1002. Network module 1015 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and can take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 can be a client device, such as thin client, heavy client, mainframe computer and/or desktop computer.

REMOTE SERVER 1004 is any computer system that serves at least some data and/or functionality to computer 1001. Remote server 1004 can be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data can be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs can be stored as images and can be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware and firmware allowing public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components;
a processor that executes computer executable components stored in the memory, wherein the computer executable components comprise:
a scheduling component that creates an operations schedule for executing a quantum circuit on a quantum computer, wherein creating the operations schedule comprises determining an idle time between a first operation and a second operation on a qubit in the quantum circuit and reducing the idle time between the first operation and the second operation to create the operations schedule.

2. The system of claim 1, wherein the creating the operations schedule further comprises ordering quantum circuit operations using as soon as possible (ASAP) or as late as possible (ALAP) scheduling.

3. The system of claim 1, wherein the computer executable components further comprise an execution component that performs the operations schedule on the quantum computer.

4. The system of claim 2, wherein the reducing the idle time for ASAP scheduling comprises:
determining, for each operation G in the quantum circuit in reverse topological order, an idle time behind operation G over all qubits on which operation G acts; and
moving scheduling of operation G backwards in response to a determining that the idle time is non-zero.

5. The system of claim 2, wherein the reducing the idle time for ALAP scheduling comprises:
determining, for each operation G in the quantum circuit in topological order, an idle time in front of operation G over all qubits on which operation G acts; and
moving scheduling of operation G forward in response to a determining that the idle time is non-zero.

6. The system of claim 1, wherein the reducing the idle time reduces error of the quantum circuit.

7. The system of claim 1, wherein the scheduling component stores the operations schedule in a database.

8. A computer implemented method comprising:
creating, by a system operatively coupled to a processor, an operations schedule for executing a quantum circuit on a quantum computer, wherein creating the operations schedule comprises determining an idle time between a first operation and a second operation on a qubit in the quantum circuit and reducing the idle time between the first operation and the second operation to create the operations schedule.

9. The method of claim 8, wherein the creating the operations schedule further comprises ordering quantum circuit operations using as soon as possible (ASAP) or as late as possible (ALAP) scheduling.

10. The method of claim 8, further comprising, executing, by the system, the operations schedule on the quantum computer.

11. The method of claim 9, wherein the reducing the idle time for ASAP scheduling comprises:
determining, by the system, for each operation G in the quantum circuit in reverse topological order, an idle time behind operation G over all qubits on which operation G acts; and
moving, by the system, scheduling of operation G backwards in response to a determining that the idle time is non-zero.

12. The method of claim 9, wherein the reducing the idle time for ALAP scheduling comprises:
determining, by the system, for each operation G in the quantum circuit in topological order, an idle time in front of operation G over all qubits on which operation G acts; and
moving by the system, scheduling of operation G forward in response to a determining that the idle time is non-zero.

13. The method of claim 8, wherein the reducing the idle time reduces error of the quantum circuit.

14. The method of claim 8, further comprising, storing, by the system, the operations schedule in a database.

15. A computer program product, comprising a computer readable storage medium having program instructions embodied therewith, the program instructions executable by a processor to cause the processor to:
create, by the processor, an operations schedule for executing a quantum circuit on a quantum computer, wherein creating the operations schedule comprises determining an idle time between a first operation and a second operation on a qubit in the quantum circuit and reducing the idle time between the first operation and the second operation to create the operations schedule.

16. The computer program product of claim 15, wherein the creating the operations schedule further comprises ordering quantum circuit operations using as soon as possible (ASAP) or as late as possible (ALAP) scheduling.

17. The computer program product of claim 15, wherein the program instructions are further executable to cause the processor to perform the operations schedule on a quantum computer.

18. The computer program product of claim 16, wherein the reducing the idle time for ASAP scheduling comprises:
determining, for each operation G in the quantum circuit in reverse topological order, an idle time behind operation G over all qubits on which operation G acts; and
moving scheduling of operation G backwards in response to a determining that the idle time is non-zero.

19. The computer program product of claim 16, wherein the reducing the idle time for ALAP scheduling comprises:
determining, for each operation G in the quantum circuit in topological order, a idle time in front of operation G over all qubits on which operation G acts; and
moving scheduling of operation G forward in response to a determining that the idle time is non-zero.

20. The computer program product of claim 15, wherein the reducing the idle time reduces error of the quantum circuit.
